(19) United States
(12) Patent Application Publication
(10) Pub. No.: US 2006/0099555 A1
(43) Pub. Date: May 11, 2006

(54) Goal tracking device and method of tracking the completion of goals

(76) Inventor: Andris Talbergs, Jurmala (LV)

Correspondence Address: Clyde L. Smith;Thompson Coburn LLP, One US Bank Plaza, St. Louis, MO, 63101-9928, US

(21) Appl. No.: 10/966,742

(22) Filed: Oct. 15, 2004

(51) Int. Cl. G09B 19/00

(52) U.S. Cl. 434/236

(57) ABSTRACT

A goal tracking device comprises an elongate member, an impediment member, and a plurality of marker members. The impediment member is connected to the elongate member and defines first and second segments of the portion of the elongate member. The impediment member is also biased from an unblocking position to a blocking position. Each marker member is slidably connected to the elongate member in a manner such that it is movable from the first segment to the second segment of the elongate member. The impediment member prevents each marker member from moving from the first segment to the second segment of the elongate member when the impediment member is in the blocking position. In contrast, the impediment member allows each marker member to slidably move from the first segment to the second segment of the elongate member when the impediment member is in the unblocking position.

### BACKGROUND OF THE INVENTION

This invention pertains to goal tracking devices and to methods of tracking the completion of goals. More particularly, this invention pertains to a device having a plurality of marker members that can be slid along an elongate member to represent and track completed and uncompleted goals.

It is well known that the tracking of the completion of goals or achievements can be useful in increasing a person's motivation to achieve or accomplish such goals and achievements. By tracking the individual completion of separate goals, a person is able to visually see progress being made, and is thereby motivated to complete the next goal he or she has set for himself or herself. Moreover, the display of the progress of goal completion can be a useful means for generating motivation in others.

In view of the motivational benefits associated with the tracking of the completion of goals or accomplishments, many devices and methods for tracking goals have been developed and practiced. However, there remains room for improvement.

### SUMMARY OF THE INVENTION

The present invention provides a goal tracking device for visually tracking the completion of goals in a manner that motivates the individual completing such goals, and others that observe such goals being tracked. Moreover the goal tracking device of the present invention is simple to use and versatile.

In one aspect of the invention, an apparatus comprises an elongate member, first and second stop members, an impediment member, and a plurality of marker members. The elongate member has a longitudinal length. The first and second stop members are connected to the elongate member and are spaced apart from each other along the longitudinal length of the elongate member in a manner defining a portion of the elongate member therebetween. The impediment member is operatively connected to the elongate member in a manner such that the impediment member is positioned at a location along the portion of the elongate member that defines opposite and adjacent first and second segments of the portion of the elongate member. The impediment member is moveable between a blocking position and an unblocking position relative to the elongate member, and is also biased from the unblocking position to the blocking position. The plurality of marker members are slidably connected to the portion of the elongate member in a manner such that each of the plurality of marker members is movable from the first segment of the elongate member to the second segment of the elongate member and vice versa. The first and second stop members are configured and adapted to limit movement of the marker members relative to the elongate member. The impediment member prevents each of the marker members from slidably moving from the first segment of the elongate member to the second segment of the elongate member and vice versa when the impediment member is in the blocking position. In contrast, the impediment member allows each of the marker members to slidably move from the first segment of the elongate member to the second segment of the elongate member and vice versa when the impediment member is in the unblocking position.

In another aspect of the invention, a method of tracking goals comprises a step of providing a goal tracking device. The goal tracking device comprises an elongate member having a longitudinal length, first and second stop members, an impediment member, and a plurality of marker members. The first and second stop members are connected to the elongate member and are spaced apart from each other along the longitudinal length of the elongate member in a manner defining a portion of the elongate member therebetween. The impediment member is operatively connected to the elongate member in a manner such that the impediment member is positioned at a location along the portion of the elongate member that defines opposite and adjacent first and second segments of the portion of the elongate member. The impediment member is moveable between a blocking position and an unblocking position relative to the elongate member, and is also biased from the unblocking position to the blocking position. The plurality of marker members are slidably connected to the portion of the elongate member in a manner such that each of the plurality of marker members is movable from the first segment of the elongate member to the second segment of the elongate member and vice versa. The first and second stop members are configured and adapted to limit movement of the marker members relative to the elongate member. The impediment member prevents each of the marker members from moving from the first segment of the elongate member to the second segment of the elongate member and vice versa when the impediment member is in the blocking position. In contrast, the impediment member allows each of the marker members to move from the first segment of the elongate member to the second segment of the elongate member and vice versa when the impediment member is in the unblocking position. The method further comprises a step of representing a plurality of unaccomplished goals by positioning each of the marker members along the first segment of the elongate member, and a step of accomplishing one of the unaccomplished goals in a manner such that the one of the unaccomplished goals becomes an accomplished goal. Still further, this method comprises a step of slidably moving a first one of the marker members from the first segment of the elongate member to the second segment of the elongate member in a manner such that the position of the first marker member along the second segment of the elongate member represents the accomplished goal. The moving of the first marker member from the first segment of the elongate member to the second segment of the elongate member requires the impediment member to be positioned in the unblocking position when the first marker member passes from the first segment of the elongate member to the second segment of the elongate member.

In yet another aspect of the invention, a method of tracking goals comprises a step of providing a goal tracking device that comprises an elongate member, an impediment member, and a plurality of marker members. The elongate member has a longitudinal length, and separate first and second segments. The impediment member is operatively connected to the elongate member in a manner such that the impediment member is positioned between the first and second segments of the elongate member, and is moveable between a blocking position and an unblocking position relative to the elongate member. The impediment member is also biased from the unblocking position to the blocking position. The plurality of marker members are slidably connected to the elongate member in a manner such that each of the plurality of marker members is movable from the first segment of the elongate member to the second segment of the elongate member and vice versa. The impediment member prevents each of the marker members from moving from the first segment of the elongate member to the second segment of the elongate member and vice versa when the impediment member is in the blocking position. In contrast, the impediment member allows each of the marker members to move from the first segment of the elongate member to the second segment of the elongate member and vice versa when the impediment member is in the unblocking position. The method further comprises a step of representing a plurality of unaccomplished goals by positioning each of the marker members along the first segment of the elongate member, and a step of accomplishing one of the unaccomplished goals in a manner such that the one of the unaccomplished goals becomes an accomplished goal. Still further, the method comprises a step of slidably moving a first one of the marker members from the first segment of the elongate member to the second segment of the elongate member in a manner such that the position of the first marker member along the second segment of the elongate member represents the accomplished goal. The moving of the first marker member from the first segment of the elongate member to the second segment of the elongate member requires the impediment member to be positioned in the unblocking position when the one of the marker members passes from the first segment of the elongate member to the second segment of the elongate member.

While the principal advantages and features of the invention have been described above, a more complete and thorough understanding of the invention may be obtained by referring to the drawing figures and the detailed description of various embodiments, which follow.

### BRIEF DESCRIPTION OF THE DRAWINGS

FIG. 1 is a perspective view of a first embodiment of a goal tracking device in accordance with the invention.

FIG. 2 is a front view of the goal tracking device shown in FIG. 1.

FIG. 3 is a cross-sectional view of the goal tracking device shown in FIGS. 1 and 2, taken about the device's plane symmetry and with the impediment member in its blocking position.

FIG. 4 is a cross-sectional view similar to FIG. 3, but is shown with the impediment member in its unblocking position.

FIG. 5 is a partial front view of an alternative embodiment of an impediment member for use in constructing a goal tracking device in accordance with the invention, and is shown in cross-section.

FIG. 6 is a partial front view of another alternative embodiment of an impediment member for use in constructing a goal tracking device in accordance with the invention.

FIG. 7 is a partial front view of yet another alternative embodiment of an impediment member for use in constructing a goal tracking device in accordance with the invention, and is shown in cross-section.

FIG. 8 is a perspective view of another embodiment of a goal tracking device in accordance with the invention.

FIG. 9 is a perspective view of yet another embodiment of a goal tracking device in accordance with the invention.

Reference characters in the written specification indicate corresponding items shown throughout the drawing figures.

### DETAILED DESCRIPTION OF THE PREFERRED EMBODIMENTS OF THE INVENTION

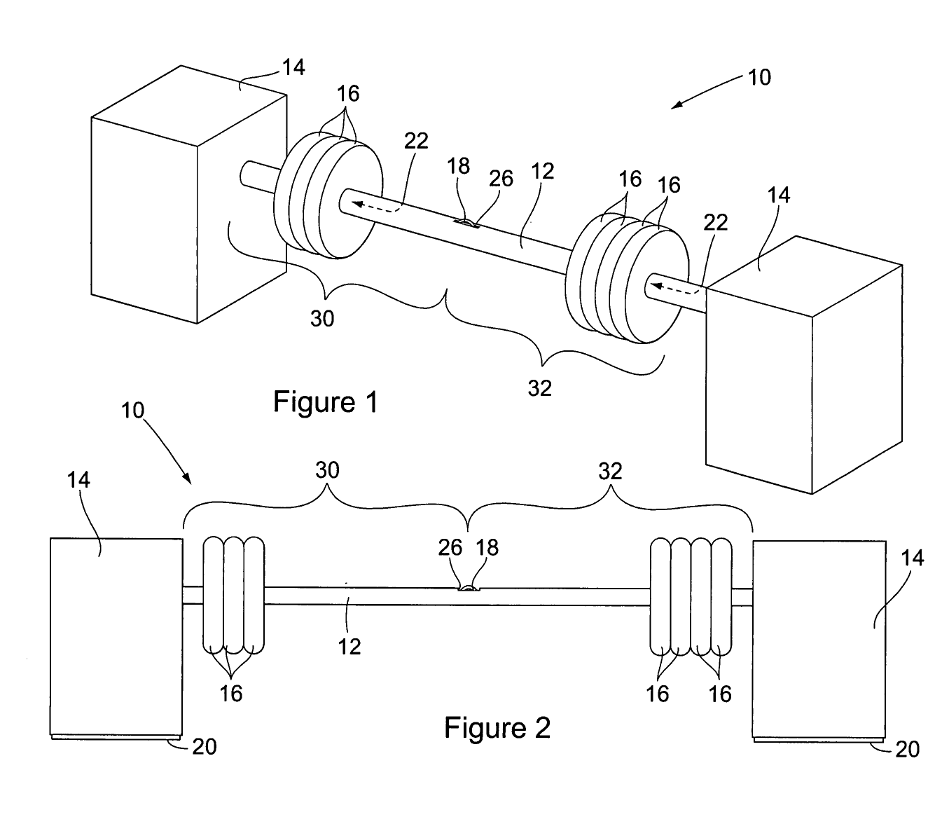

A first embodiment of a goal tracking device in accordance with the invention is shown in FIGS. 1-4, and is indicated in the drawing figures by reference numeral 10. In general, the goal tracking device 10 comprises an elongate member 12, a pair of stop members 14, a plurality of marker members 16, and an impediment member 18.

The elongate member 12 of the goal tacking device 10 is preferably formed of metal and is preferably a cylindrical tube. Although shown straight, the elongate member 12 could also extend longitudinally along a curved trajectory, or a trajectory of any other shape. The stop members 14 are connected to the elongate member 12 and are preferably fixed in position relative to the elongate member. Additionally, the stop members 14 are spaced apart from each other in a manner such that a portion of the elongate member 12 extends longitudinally from one of the stop members to the other. The stop members are preferably ornamental and decorative and may have various alternative shapes. However, for the purpose of describing this embodiment of the invention, the stop members 14 are shown as being merely cubic in shape. The base of each stop member may comprise an adhesive portion 20, such as an adhesive pad as shown in FIG. 2. Preferably, any such adhesive is covered by a removable layer of release film (not shown) prior to utilizing the adhesive as described below.

The plurality of marker members 16 are each slidably connected to the elongate member 12 along the portion of the elongate member that extends longitudinally from one of the stop members 14 to the other. Preferably, each marker member 16 comprises an aperture 22 that is adapted and configured to allow the elongate member 12 to slide therethrough. The marker members 16 are preferably each formed as a stiff object with a centrally positioned aperture 22. Additionally, although the marker members 16 are shown as being discoidal in shape, it should be appreciated that the marker members may have ornamental and fanciful shapes or otherwise be decorative in nature.

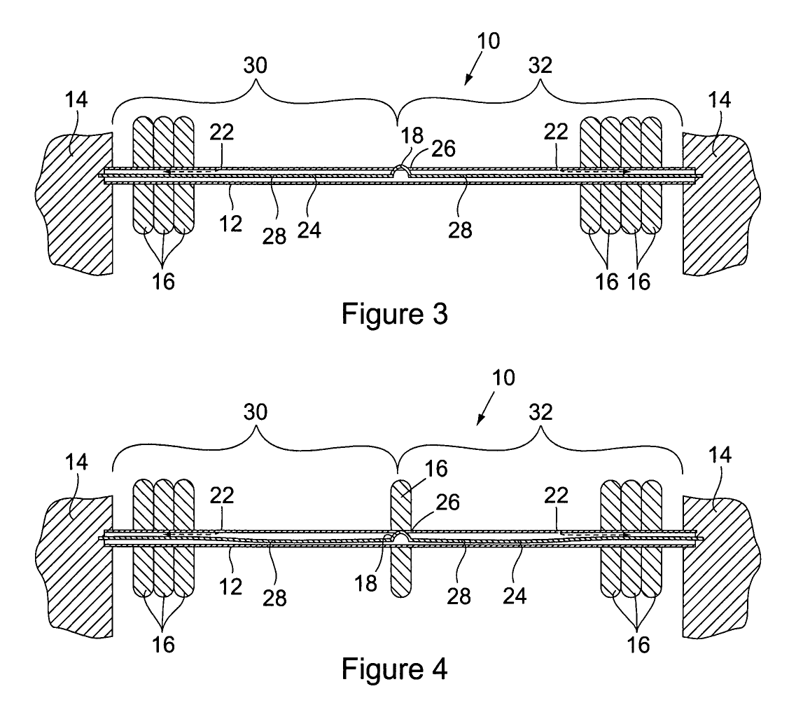

The impediment member 18 of the goal tracking device 10 is preferably a partial loop of a portion of a bent piece of spring wire 24 and preferably extends through a slot 26 formed in the elongate member 12. In addition to the impediment member 18, the piece of spring wire 24 preferably also forms a pair of beams 28 that extend in a cantilevered manner from the impediment member in opposite directions. The spring wire 24 is preferably configured in a manner such that the beams 28 support and resiliently bias the impediment member 18 in a position such the impediment member extends outward from the elongate member 12 (as shown in FIG. 3). This position of the impediment member 18 constitutes a blocking position, as is explained below. However, the spring wire 24 is also preferably configured in a manner such that the application of a force acting on the impediment member 18 can cause the beams 28 supporting the impediment member to deflect and thereby allow the impediment member to move at least partially more into the elongate member 12 (as shown in FIG. 4). This alternative position of the impediment member 18 constitutes a unblocking position, as is also explained below. It should be appreciated that upon the release of the force, the impediment member 18 resiliently returns to the blocking position. It should also be appreciated that the position of the impediment member 18 along the elongate member 12 defines separate and adjacent first 30 and second 32 segments of the portion of the elongate member that extends between the stop members 14.

In use, the goal tracking device 10 can be secured to any desired surface via the adhesive portions 20 of the stop members 14. This is preferably done by removing the release film from the adhesive portions 20 and simply pressing the adhesive portions to the surface. The adhesive portions 20 are preferably configured to adhere the goal tracking device 10 to the surface in a manner such that a force greater than the total weight of the goal tracking device is required to separate the goal tracking device from the surface. This allows the goal tracking device 10 to be secured to a vertical surface, or even to hang from a horizontal surface. Alternatively, regardless of whether or not the goal tracking device 10 comprises adhesive portions 20, the device can simply be placed on a generally horizontal surface. Moreover, as is illustrated below by way of example, the goal tracking device can be otherwise specifically adapted to be attached to various other objects as desired.

When the goal tracking device 10 is in use, a person can assign or relate one or more unachieved goals to one or more of the marker members 16. Initially, the marker members 16 are preferably all positioned along the first segment 30 of the elongate member 12. Upon completing or accomplishing a goal, one or more of the marker members 16 can be moved along the elongate member 12 from the first segment 30 to the second segment 32 of the elongate member. Thus, those marker members 16 positioned along the second segment 32 of the elongate member 12 can symbolize or represent completed or accomplished goals.

However, the movement of the marker members 16 from the first segment 30 of the elongate member 12 to the second segment 32 of the elongate member, and vice versa, is impeded by the impediment member 18. In particular, while the aperture 22 of each marker member 16 is dimensioned to allow the marker member to slidably move along the elongate member 12, the aperture is also dimensioned such that the impediment member 18 will engage the marker member in a manner preventing the marker member from moving from the first segment 30 of the elongate member to the second segment 32 of the elongate member, and vice versa, when the impediment member is in the blocking position. Nonetheless, by applying force in excess of a threshold force on the marker member 16 relative to the elongate member 12 when the marker member is engaged with the impediment member 18, the contact force between the marker member and the impediment member will resiliently deflect the impediment member to the unblocking position, as is shown in FIG. 4. In the unblocking position, the impediment member 18 can be passed through the aperture 22 of the marker member 16 and thereby allow the marker member to move from the first segment 30 of the elongate member 12 to the second segment 32 of the elongate member, and vice versa.

In view of the foregoing description of goal tracking device 10, it should be appreciated that individuals can utilize the goal tracking device to track the completion of goals based on the position of the marker members 16 along the elongate member 12. It should also be appreciated that the impediment member 18 prevents the marker members 16 from unintentionally moving from the first segment 30 of the elongate member 12 to the second segment 32 of the elongate member, and vice versa. Additionally, the stop members 14 limit the movement of the marker members 16 in a manner preventing the marker members from being disconnected to the elongate member 12. Thus, if the goal tracking device 10 is bumped or falls from a surface, it is less likely that the marker members 16 will thereby inadvertently be moved from one of the first 30 and second segments 32 of the elongate member 12 to the other, or become completely removed from the elongate member, as a result.

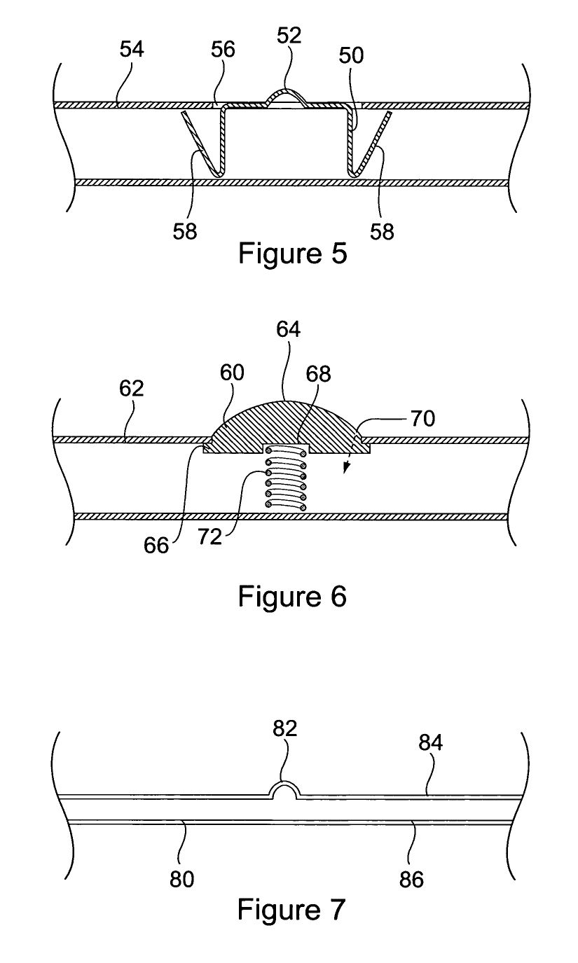

Having described the configuration and use of the goal tracking device 10 shown in FIGS. 1-4, various alternative embodiments will now be described. FIG. 5 depicts an alternative embodiment of a spring wire 50 that forms an impediment member 52 that is similar in purpose and function to the impediment member 18 of the goal tracking device 10 shown in FIGS. 1-4. However, the spring wire 50 shown in FIG. 5 is configured and adapted to be assembled to a tubular elongate member 54 simply by pressing the spring wire through a slot 56 formed through the wall of the elongate member. In particular, the spring wire 50 has a pair of opposite tangs 58 that extend beyond the lengthwise bounds of the slot 56. The tangs 58 extend in a sloped manner such that the pressing of the spring wire into the slot causes the tangs to deflect toward each other against the bounds of the slot 56 in a manner such that they can pass through the slot and into the tubular elongate member 54. Once the tangs 58 pass through the slot 56, the tangs resiliently deflect apart and thereby prevent the spring wire 50 from passing back out of the elongate member 54 through the slot. Aside from these differences, the resiliency of the spring wire 50 resiliently biases the impediment member 52 in a manner similar to the manner of the spring wire 24 of the goal tracking device 10 described above.

FIG. 6 depicts another alternative embodiment of an impediment member 60 for use in connection with a tubular elongate member 62. This impediment member 60 is formed as a monolithic piece plastic having an arcuate upper surface 64, a lower rim 66, and a pocket 68 formed in its underside. The arcuate upper surface 64 of the impediment member 60 is configured to extend through the slot 70 formed in the elongate member 62. However, the rim 66 of the impediment member 60 extends beyond the bounds of the slot 70 and thereby prevents the impediment member from passing completely out of the elongate member 62 through the slot. A compression helical spring 72 is also provided and is partially received in the pocket 68 of the impediment member 60. The helical spring 72 engages the elongate member 62 such that the helical spring is partially compressed and thereby biases the impediment member 60 toward its blocking position, as shown in FIG. 6. As should be appreciated, a force acting downward on the impediment member 60 can overcome the biasing force of the helical spring 72 and thereby move the impediment member more into the elongate member 62 such that the impediment member will be in an unblocking position.

FIG. 7 depicts an alternative embodiment of an elongate member 80 and an impediment member 82. In this embodiment, the elongate member 80 is formed by first 84 and second 86 wires that, in general, extend parallel to each other in a spaced apart manner. The first wire 84 also forms the impediment member 82, which is preferably a partial loop. The spacing of the first 84 and second 86 wires is preferably such that the parallel portions of the first and second wires can pass through the apertures of marker members (not shown) connected thereto with little or no resistance. However, in order for a marker member to pass along the elongate member 80 from one side of the impediment member 82 to the other, the first 84 and second 86 wires must resiliently deflect toward each other such that the impediment member and the second wire can pass through the aperture of the marker member. It should be appreciated that either the first wire 84, the second wire 86, or both could resiliently deform as this occurs.

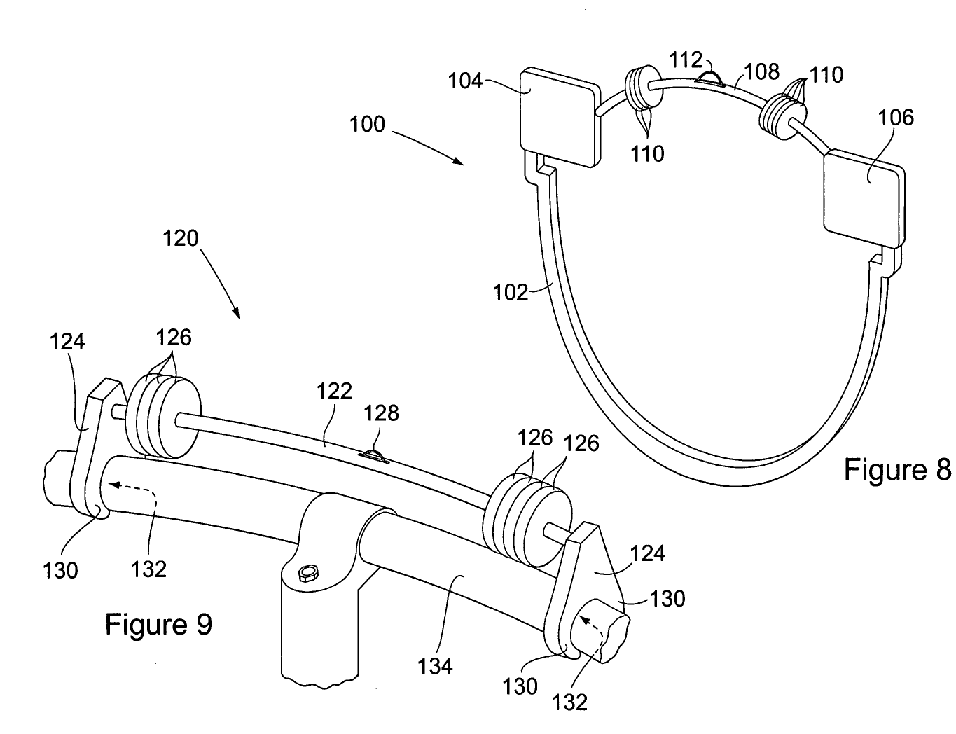

Another embodiment of a goal tracking device 100 is shown in FIG. 8. Unlike the goal tracking device 10 shown in FIGS. 1-4, this goal tracking device 100 is configured and adapted to be worn as a bracelet or necklace, depnding upon its size. In particular, this goal tracking device 100 comprises a connecting member 102 that joins the first 104 and second 106 stop members of the goal tracking device, and that is separate from the elongate member 108 of the device, thereby configuring the goal tracking device in a loop through which a person's wrist or neck can extend. It should be appreciated that, similar to the goal tracking device 10 shown in FIGS. 1-4, this goal tracking device 100 also comprises a plurality of marker members 110 and an impediment member 112 that are operably in the manner described above. Additionally, it should be appreciated that the connecting member 102 is preferably configured to be disconnected from either the first 104 or second 106 stop members, or both, in a manner such that the loop formed by the goal tracking device 100 can be opened. Similarly, the connecting member may be separable into multiple portions via a clasp or the like. This allows the goal tracking device to be attached to and removed from a person's wrist or neck without configuring the loop to be so large as to allow the person's hand or head to pass therethrough.

Another embodiment of a goal tracking device 120 in accordance with the invention is shown in FIG. 9. Like the goal tracking device 10 shown in FIGS. 1-4, this goal tracking device 120 comprises an elongate member 122, a pair of stop members 124, a plurality of marker members 126, and an impediment member 128, which generally function in a manner similar to such elements of the goal tracking device 10 shown in FIGS. 1-4. However, unlike the goal tracking device 10 shown in FIGS. 1-4, the stop members 124 of the goal tracking device 120 shown in FIG. 9 each comprise a pair of tines 130 that extend partially around an opening 132 that extends through the respective stop member. The opening 132 through each of the stop members is preferably configured to allow a handlebar 134 of a bicycle to extend therethrough, as is shown in FIG. 9. The tines 130 of each of the stop members 124 are preferably configured to extend more than halfway, but less than all the way, around the handlebar 134 of the bicycle. Additionally, the tines 130 of each stop member 124 are preferably resiliently deflectable away from each other such that each of the stop members can be snapped onto and removed from the handlebar 134 of the bicycle. Additionally, the opening 132 through each of the stop members 124 is preferably configured to be slightly smaller in diameter than the handlebar 134 of the bicycle such that tines 130 of each of the stop members remain partially deflected from each other when the stop members are attached to the handlebar. As such the tines 130 of each of the stop members 124 clamps against the handlebar 134 and creates friction that prevents the goal tracking device 120 from pivoting about the handlebar.

While the present invention has been described in reference to specific embodiments, in light of the foregoing, it should be understood that all matter contained in the above description or shown in the accompanying drawing figures is intended to be interpreted as illustrative and not in a limiting sense and that various modifications and variations of the invention may be constructed without departing from the scope of the invention defined by the following claims. For example, it should be appreciated that the stop members need not be connected to the terminal ends of the elongate member and that the elongate member could extend beyond the stop members. Moreover, the elongate member could be all or partially flexible in a manner such that its trajectory is not fixed. Furthermore, the impediment member need not take the form of the particular embodiments described herein and could have numerous different forms, such as being monolithically formed as a single piece together with the elongate member. Still further, a looped version of the goal tracking device need not necessarily comprise any stop members. Thus, other possible variations and modifications should be appreciated.

Furthermore, it should be understood that when introducing elements of the present invention in the claims or in the above description of the preferred embodiment of the invention, the terms “comprising,” “including,” and “having” are intended to be open-ended and mean that there may be additional elements other than the listed elements. Similarly, the term “portion” should be construed as meaning some or all of the item or element that it qualifies.

What is claimed is:

1. An apparatus, comprising:
an elongate member having a longitudinal length;
first and second stop members, the first and second stop members being connected to the elongate member and being spaced apart from each other along the longitudinal length of the elongate member in a manner defining a portion of the elongate member therebetween;
an impediment member, the impediment member being operatively connected to the elongate member in a manner such that the impediment member is positioned at a location along the portion of the elongate member that defines opposite and adjacent first and second segments of the portion of the elongate member, the impediment member being moveable between a blocking position and an unblocking position relative to the elongate member, the impediment member also being biased from the unblocking position to the blocking position; and
a plurality of marker members, the plurality of marker members being slidably connected to the portion of the elongate member in a manner such that each of the plurality of marker members is movable from the first segment of the elongate member to the second segment of the elongate member and vice versa, the first and second stop members being configured and adapted to limit movement of the marker members relative to the elongate member, the impediment member preventing each of the marker members from slidably moving from the first segment of the elongate member to the second segment of the elongate member and vice versa when the impediment member is in the blocking position, the impediment member allowing each of the marker members to slidably move from the first segment of the elongate member to the second segment of the elongate member and vice versa when the impediment member is in the unblocking position.

2. An apparatus in accordance with claim 1 wherein each of the marker members has an aperture that extends therethrough, the elongate member passing through the aperture of each of the marker members, the impediment member being configured and adapted to pass through the aperture of each of the marker members when the impediment member is in the unblocking position.

3. An apparatus in accordance with claim 1 wherein the apparatus has a total weight and the first and second stop members each comprise an adhesive portion, the adhesive portions of the first and second stop members being configured and adapted to secure the apparatus to a separate object in a manner such that a force greater than the total weight of the apparatus is required to unsecure the apparatus from the separate object.

4. An apparatus in accordance with claim 1 wherein each of the first and second stop members comprises an opening bounded by a portion of the respective one of the first and second stop members, the portion of each of the first and second stop members forming in excess of one half of a loop around the opening of the respective first and second stop members in a manner such that the apparatus is configured and adapted to be secured to a separate object via interlocking geometry created by positioning portions of the separate object in the openings of the first and second stop members.

5. An apparatus in accordance with claim 1 wherein the portion of the elongate member is stiff and extends longitudinally along a non-linear trajectory.

6. An apparatus in accordance with claim 5 wherein the non-linear trajectory is arcuate.

7. An apparatus in accordance with claim 1 wherein the apparatus further comprises a connecting member that connects to each of the first and second stop members in a manner such that the apparatus forms a closed loop.

8. An apparatus in accordance with claim 7 wherein the connecting member is adapted and configured to selectively connect the first and second stop members to each other.

9. A method of tracking goals comprising:
providing a goal tracking device that comprises an elongate member having a longitudinal length, first and second stop members, an impediment member, and a plurality of marker members, the first and second stop members being connected to the elongate member and being spaced apart from each other along the longitudinal length of the elongate member in a manner defining a portion of the elongate member therebetween, the impediment member being operatively connected to the elongate member in a manner such that the impediment member is positioned at a location along the portion of the elongate member that defines opposite and adjacent first and second segments of the portion of the elongate member, the impediment member being moveable between a blocking position and an unblocking position relative to the elongate member, the impediment member also being biased from the unblocking position to the blocking position, the plurality of marker members being slidably connected to the portion of the elongate member in a manner such that each of the plurality of marker members is movable from the first segment of the elongate member to the second segment of the elongate member and vice versa, the first and second stop members being configured and adapted to limit movement of the marker members relative to the elongate member, the impediment member preventing each of the marker members from moving from the first segment of the elongate member to the second segment of the elongate member and vice versa when the impediment member is in the blocking position, the impediment member allowing each of the marker members to move from the first segment of the elongate member to the second segment of the elongate member and vice versa when the impediment member is in the unblocking position;
representing a plurality of unaccomplished goals by positioning each of the marker members along the first segment of the elongate member;
accomplishing one of the unaccomplished goals in a manner such that the one of the unaccomplished goals becomes an accomplished goal;
slidably moving a first one of the marker members from the first segment of the elongate member to the second segment of the elongate member in a manner such that the position of the first marker member along the second segment of the elongate member represents the accomplished goal, the moving of the first marker member from the first segment of the elongate member to the second segment of the elongate member requiring the impediment member to be positioned in the unblocking position when the first marker member passes from the first segment of the elongate member to the second segment of the elongate member.

10. A method in accordance with claim 9 wherein the step of providing the goal tracking device occurs in a manner such that each of the marker members has an aperture that extends therethrough and such that the elongate member passes through the aperture of each of the marker members, and wherein the step of slidably moving the first marker member from the first segment of the elongate member to the second segment of the elongate member comprises passing the impediment member through the aperture of the first marker member when the impediment member is in the unblocking position.

11. A method in accordance with claim 9 wherein the step of slidably moving the first marker member from the first segment of the elongate member to the second segment of the elongate member comprises moving the impediment member from the blocking position to the unblocking position by engaging the impediment member with the first marker member and exerting a force in excess of a threshold force on the first marker member relative to the elongate member, the threshold force being a force sufficient to cause the first marker member to exert a contact force on the impediment member that overcomes the biased nature of the impediment member.

12. A method in accordance with claim 9 wherein the step of providing the goal tracking device occurs in a manner such that at least one of the first and second stop members comprises an adhesive portion and a layer of release film, the layer of release film being removably engaged with the adhesive portion, and wherein the method further comprises steps of:
providing an object separate from the goal tracking device;
removing the layer of release film from the adhesive portion; and
securing the goal tracking device to the object via engaging the adhesive portion to the object after the step of removing the layer of release film from the adhesive portion.

13. A method in accordance with claim 9 wherein the step of providing the goal tracking device occurs in a manner such that each of the first and second stop members comprises a pair of tines that are resiliently deflectable relative to each other, each of the pairs of tines being configured and adapted to resiliently clamp the respective one of the first and second stop members to another object placed between such pair of tines, and wherein the method further comprises steps of:
providing an object separate from the goal tracking device; and
securing the goal tracking device to the object by clamping each of the pairs of tines to the object in a manner such that such tines are resiliently deflected apart from each other by the object and thereby exert a force on the object.

14. A method in accordance with claim 13 wherein the step of providing the object separate from the goal tracking device occurs in a manner such that the object is a bicycle, the bicycle comprising a handlebar, and wherein the step securing the goal tracking device to the object comprises clamping each of the pairs of tines to the handlebar of the bicycle in a manner such that the first and second stop members of the goal tracking device become interlocked in geometry with the handlebar of the bicycle.

15. A method in accordance with claim 9 wherein the step of providing the goal tracking device occurs in a manner such that the goal tracking device comprises a connecting member that connects to each of the first and second stop members in a manner such that the goal tracking device forms a closed loop, the method further comprising a step of supporting the goal tracking device from an appendage of a person by extending the appendage of the person through the closed loop of the goal tracking device.

16. A method of tracking goals comprising:
providing a goal tracking device that comprises an elongate member, an impediment member, and a plurality of marker members, the elongate member having a longitudinal length, the elongate member having separate first and second segments, the impediment member being operatively connected to the elongate member in a manner such that the impediment member is positioned between the first and second segments of the elongate member, the impediment member being moveable between a blocking position and an unblocking position relative to the elongate member, the impediment member also being biased from the unblocking position to the blocking position, the plurality of marker members being slidably connected to the elongate member in a manner such that each of the plurality of marker members is movable from the first segment of the elongate member to the second segment of the elongate member and vice versa, the impediment member preventing each of the marker members from moving from the first segment of the elongate member to the second segment of the elongate member and vice versa when the impediment member is in the blocking position, the impediment member allowing each of the marker members to move from the first segment of the elongate member to the second segment of the elongate member and vice versa when the impediment member is in the unblocking position;
representing a plurality of unaccomplished goals by positioning each of the marker members along the first segment of the elongate member;
accomplishing one of the unaccomplished goals in a manner such that the one of the unaccomplished goals becomes an accomplished goal;
slidably moving a first one of the marker members from the first segment of the elongate member to the second segment of the elongate member in a manner such that the position of the first marker member along the second segment of the elongate member represents the accomplished goal, the moving of the first marker member from the first segment of the elongate member to the second segment of the elongate member requiring the impediment member to be positioned in the unblocking position when the one of the marker members passes from the first segment of the elongate member to the second segment of the elongate member.

17. A method in accordance with claim 16 wherein the step of providing the goal tracking device occurs in a manner such that the elongate member is adapted and configured such that the goal tracking device forms a closed loop that is at least partially defined by the elongate member, the method further comprising a step of supporting the goal tracking device from an appendage of a person by extending the appendage of the person through the closed loop of the goal tracking device.

18. A method in accordance with claim 16 wherein the step of providing the goal tracking device occurs in a manner such that the elongate member is stiff and arcuate in shape, and wherein the step of slidably moving the first marker member from the first segment of the elongate member to the second segment of the elongate member comprises moving the first marker member along an arcuate path.

19. A method in accordance with claim 16 wherein the step of slidably moving the first marker member from the first segment of the elongate member to the second segment of the elongate member comprises moving the impediment member from the blocking position to the unblocking position by engaging the impediment member with the first marker member and exerting a force in excess of a threshold force on the first marker member relative to the elongate member, the threshold force being a force sufficient to cause the first marker member to exert a contact force on the impediment member that overcomes the biased nature of the impediment member.

20. A method in accordance with claim 16 wherein the step of providing the goal tracking device occurs in a manner such that each of the marker members has an aperture that extends therethrough and such that the elongate member passes through the aperture of each of the marker members, and wherein the step of slidably moving the first marker member from the first segment of the elongate member to the second segment of the elongate member comprises passing the impediment member through the aperture of the first marker member when the impediment member is in the unblocking position.
